(19) United States
(12) Patent Application Publication
(10) Pub. No.: US 2010/0088405 A1
(43) Pub. Date: Apr. 8, 2010

(54) Determining Network Delay and CDN Deployment

(75) Inventors: Cheng Huang, Redmond, WA (US); Jin Li, Sammamish, WA (US); Angela Wang, Hauppauge, NY (US); Keith Wimberly Ross, New York, NY (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/247,394

(22) Filed: Oct. 8, 2008

(51) Int. Cl. G06F 15/16

(52) U.S. Cl. 709/224; 709/226

(57) ABSTRACT

Charting a content distribution system (CDN) involves identifying a set of DNS servers that may be used as vantage points to test delay performance to a CDNs content server. As provided herein, to identify potential vantage point DNS servers, a set of authoritative name servers is identified and, from that set, those authoritative name servers that respond to a DNS query are identified as responsive authoritative name servers. Identifying a CDN content server that serves a particular vantage point DNS server involves retrieving an IP address for the CDN content server from a DNS query to the DNS server corresponding to the vantage point. The delay performance between the vantage point DNS server and the CDN content server can then be determined. Further, one can determine locations to deploy new data centers for a CDN based on delay performance, A delay from one or more vantage points to an existing CDN's DNS servers can be measured, and desired rank of locations can be generated. A location of a new data center can be selected based on a desired delay performance ranking.

### BACKGROUND

In a computing environment, a content distribution network (CDN) is a networked system of computers for delivering content across the Internet. CDNs are commonly designed to improve perceived performance to an end-user (e.g., a user accessing content on the Internet) in the form of faster and larger content delivery and availability. CDN content servers can be deployed in multiple global locations, often over multiple backbones and Internet service providers (ISPs). Content servers are designed to cooperate with each other to meet the needs of content end-users, often transparently moving content between content servers in a CDN in order to improve distribution based on end-user use. When a client (e.g., Internet user's computer) makes a content request the CDN typically selects a server at a location that is near the client, thereby improving a perceived end-user experience.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Current CDN designs follow two different generalized approaches. A first generalized approach utilizes a large number of scattered server clusters in order to decrease a proximity to content servers for a majority of end-users. This approach typically deploys content servers inside ISP points of presence (PoPs) as a means of improving user-perceived performance in terms of delay and throughput. A second generalized approach utilizes large content distribution centers at a few key locations, connecting these centers using private high speed connections (e.g., private fiber optic cable lines). Rather than deploying inside ISP PoPs, this approach typically places respective distribution centers at locations that are simultaneously near PoPs of many large ISPs (e.g., close to several major PoPs in a large city).

Because there are numerous competing CDNs utilizing very different design approaches, it may be desirable to have techniques and systems for evaluating performance characteristics of CDNs (e.g., delay performance, delivery speed, etc.). Further, evaluating performance characteristics of CDNs may also facilitate choosing new data center locations for an existing or new CDN entrant. Additionally, CDN evaluation techniques may be utilized to assess a CDNs existing server deployment in order to improve performance.

In order to evaluate performance of a CDN one can identify a CDN's content servers and domain name system (DNS) servers. However, without direct access to a large number of globally-distributed clients (e.g., internet user computers), it may be very difficult to properly chart a CDN network. Further, when assessing a CDN is may be desirable to accurately and comprehensively measure its delay performance. A typical CDN has two major delay components: DNS resolution delay, which is a time for the CDN's internal DNS to supply a client an address of an appropriate CDN content server; and a content-server delay, which is a round-trip time between the client and the selected content server. Quantifying the delay performance of a CDN on a large scale can typically require capturing traffic on the CDN's server, or controlling a large number of globally distributed clients.

Techniques and systems are provided herein for determining a CDNs performance by charting a CDN's content servers and DNS servers, and utilizing these servers to determine CDN network delay. In one embodiment a method for determining delay performance of an Internet content provider using network latency between a content server in a content delivery network (CDN) and domain name system (DNS) server comprises identifying a set of DNS servers for use as vantage points, for example, to test delay performance to the CDN's content servers. Identifying a set of DNS servers can comprise locating DNS servers to use as potential vantage points and, from the located DNS servers, identifying authoritative name servers that respond to a trial DNS query. In this embodiment, the method can further comprise identifying a CDN content server that serves a particular vantage point, which can include, for example, retrieving an IP address from a DNS query to the DNS server corresponding to a vantage point. In this example, the IP address can correspond to a CDN content server that is used to serve the vantage point DNS server. In this way, in this embodiment, the identified vantage point and content server can, for example, be used to determine a CDN's delay performance between the content server and vantage point DNS server.

In another embodiment, a system may be devised to determine delay performance of an Internet content provider using network latency between a content server in a content delivery network (CDN) and domain name system (DNS) server. In this embodiment, the system can comprise a vantage point identifier, which can be configured to identify a set of DNS servers for use as vantage points. The vantage point identifier can comprise a DNS server locator configured to locate DNS servers for use as potential vantage points, and a responsive authoritative name server identifier configured to identify the located DNS servers that respond to a trial DNS query. Further, in this embodiment, the system can comprise a CDN content server identifier configured to identify a CDN content server that serves a particular vantage point. The CDN content server identifier can comprise a DNS query sender, which may be configured to send a DNS query, for resolving to the CDN, to the DNS server corresponding to the vantage point, and an IP address retriever, which may be configured to retrieve an IP address corresponding to a CDN content server that serves the vantage point DNS server. Additionally, in this embodiment, the system can comprise a vantage point delay determiner, which may be configured to determine a delay between the content server and the vantage point, for example, to determine a CDN's delay performance.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary portion of a type of content distribution network (CDN).

FIG. 2 is an illustration of an exemplary portion of another type of CDN.

FIG. 3 is a flow chart diagram illustrating an exemplary method for determining delay performance of a CDN using a content server and domain name system (DNS) server.

FIG. 4 is a chart diagram illustrating an exemplary embodiment of a portion of a method for determining delay performance of a CDN using a content server and domain name system (DNS) server.

FIG. 5 is a chart diagram illustrating another exemplary embodiment of a portion of a method for determining delay performance of a CDN using a content server and domain name system (DNS) server.

FIG. 6 is a flow chart diagram illustrating another exemplary embodiment of a portion of a method for determining delay performance of a CDN using a content server and domain name system (DNS) server.

FIG. 7 is a component block diagram illustrating an exemplary embodiment determining a delay between the CDN content server and the vantage point DNS server.

FIG. 8 is a flow chart diagram illustrating an exemplary method for determining a desired location of one or more data centers for a CDN based on a delay performance.

FIG. 9 is a flow chart diagram illustrating an exemplary embodiment of a method for determining one or more locations to deploy a new data center in an existing first CDN.

FIG. 10 is an illustration of an exemplary computer-readable medium comprising processor-executable instructions configured to embody one or more of the provisions set forth herein.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

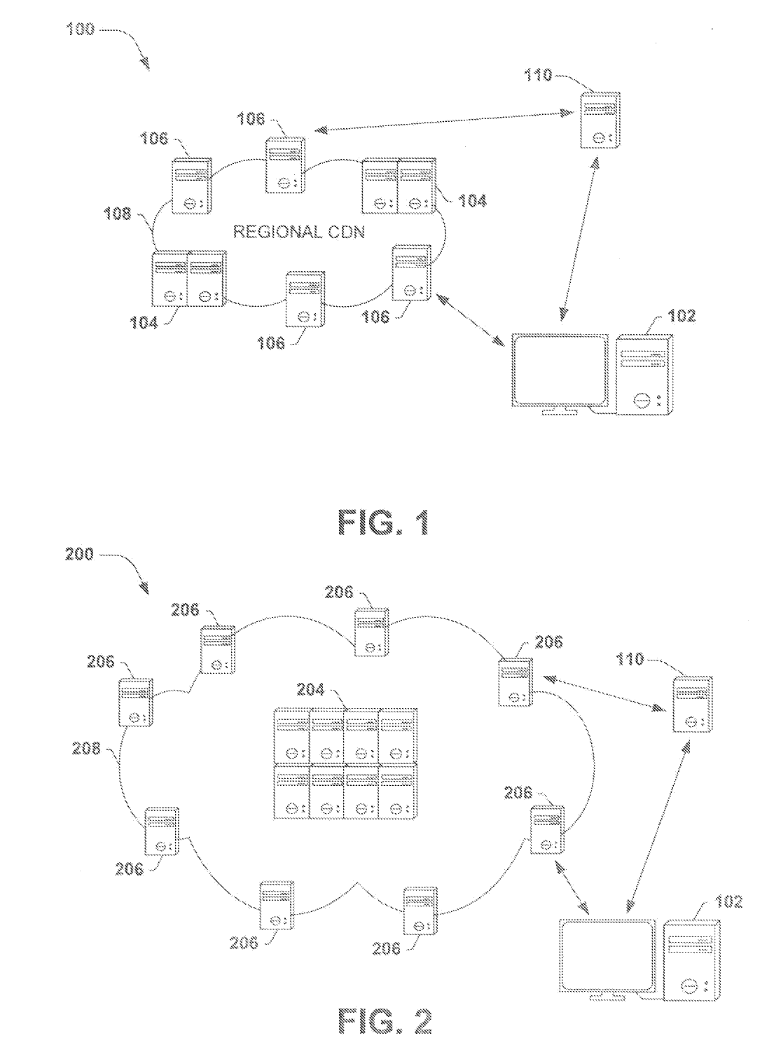

FIG. 1 is an illustration of an exemplary portion 100 of a first generalized design of content distribution network (CDN). In this example 100, a CDN may be clustered into regional portions 108, for example, serving a particular city. A regional CDN 108 may be comprised of content servers 104 deployed inside local Internet service provider (ISP) points of presence (PoPs) (e.g., AT&T's local telephone switching station in a community), for caching and delivering content to an end-user, for example. Further, the regional CDN 108 may be comprised of private DNS servers 106, which may be co-located with the content servers 104, used as authoritative name servers or for resolving canonical names (CNAMEs) to IP addresses.

As an example, a client computer 102 (e.g., an Internet user) may visit an online shopping website, which attempts to download an image of an available item to the client computer 102. A hostname for the website may first be resolved through a first query to a local DNS server 110 in a public DNS infrastructure, for example, returning a CNAME resolved to a particular CDN hostname (e.g., a query of www.website1.com may be resolved to website1content.b.CDN1hostname.net). In this example, the local DNS server 110 can issue a DNS query for resolving the CNAME to the CDN's authoritative name servers 106, which pass the query to the CDN's private DNS servers 106 to return an Internet protocol (IP) address of a CDN content server 104 that hosts the website's content (e.g., a query to resolve website1content.b.CDN1hostname.net can return an appropriate IP address for a CDN's content server).

FIG. 2 is another illustration 200 of an exemplary portion of a second generalized design of content distribution network (CDN). In this example 200, a CDN may comprise a centralized content distribution center of numerous servers 204, for example, located in an area of proximity to several ISP PoPs. Further, in this example 200, the CDN may be comprised of private DNS servers used for resolving CNAMEs to IP addresses.

As an example, as described above, a hostname for the website visited by the client computer 102 can first be resolved through a first query to a local DNS server 110, for example, returning a CNAME resolved to a particular CDN hostname (e.g., a query of www.website2.com may be resolved to websitecontent.vo.CDN2hostname.net). In this example, the DNS query for resolving the CNAME can be issued from the local DNS server 110 to the CDN's private DNS servers 206 to return an Internet protocol (IP) address of a CDN content server 204 that hosts the website's content (e.g., a query to resolve wesitecontent.vo.CDN2hostname.net may be sent to the CDN's private DNS infrastructure to return an appropriate IP address for a CDN's content server).

It will be appreciated that, while a CDN may maintain two different types of servers, content servers for serving content to clients on behalf of the CDN's customers, and DNS servers for supplying the client with a nearby content server, a same physical machine may serve as both types. For example, a CDN may use a server as both a content server and a DNS server.

In one aspect, as an example, a current CDN may wish to attempt to improve its current network delay performance by deploying a new data center comprising content servers. In this aspect, in order to develop a set of vantage points (e.g., potential locations for the new clients) for testing potential improvements to network delay performance, delays of current DNS servers can be charted. As an example, a public network of local DNS servers (LDNSs) can be charted and utilized to test whether network delay performance is improved from a location of a particular LDNS. In this way, for example, the CDN may be able to identify a location for a new data center that can improve its overall network delay performance.

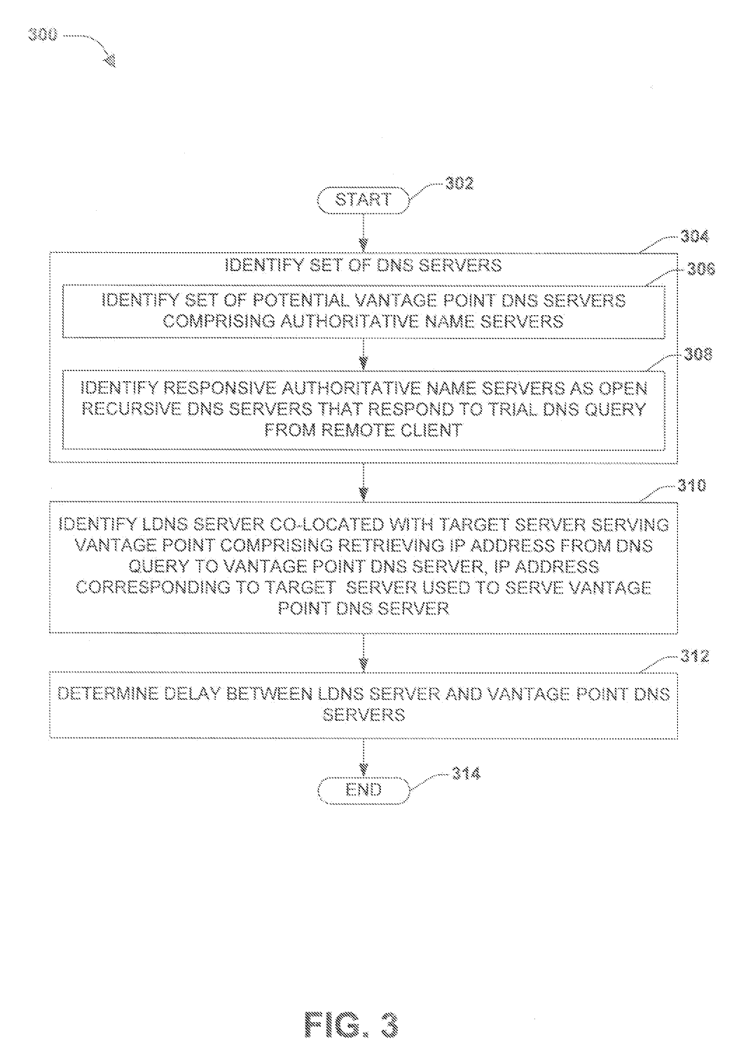

FIG. 3 is a block flow diagram of an exemplary method 300 for determining delay performance of an Internet content provider using network latency between a content server in a content delivery network (CDN) and domain name system (DNS) server. The exemplary method 300 begins at 302 and involves identifying a set of vantage point DNS servers, at 304, for example, authoritative name servers that may be used as vantage points. At 306, identifying a set of vantage point DNS servers comprises identifying a set of potential vantage point DNS servers comprising authoritative name servers. As an example, not all identified authoritative name servers may be appropriate for use as vantage points.

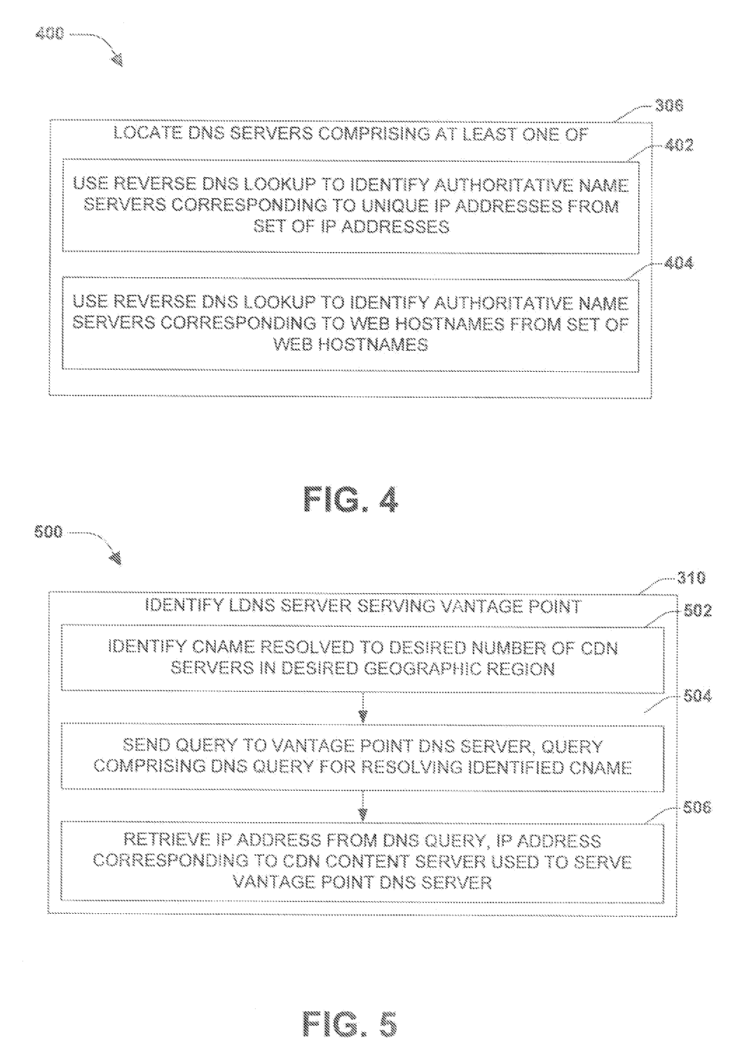

In one embodiment 400 of a method for identifying a set of potential vantage point DNS servers, at 306 in FIG. 4, a reverse DNS lookup can be used to identify authoritative name servers that correspond to IP addresses from a set of IP addresses, at 402. As an example, a set of IP addresses may be obtained from a log of clients (e.g., Internet user computers) that have accessed an online service (e.g., video content service). In this example, the IP addresses can be subjected to a reverse DNS lookup to determine their corresponding authoritative name servers.

In this embodiment, at 404, a reverse DNS lookup can be used to identify authoritative name servers that correspond to web hostnames, from a set of web hostnames. As an example, a set of web hostnames may be obtained by web crawling, using a search engine. In this example, the obtained web hostnames can be subjected to a reverse DNS lookup to determine their corresponding authoritative name servers.

Returning to FIG. 3, at 308, identifying a set of DNS servers comprises identifying those authoritative name servers that respond to a trial DNS query, out of the set of potential vantage point DNS servers. For example, one can query a set of DNS servers that are the identified authoritative name servers to determine which ones respond. In this example, those authoritative name servers that respond are considered to be open recursive DNS servers, and can be utilized to determine a delay to a CDN content server.

At 310, the exemplary method 300 comprises identifying a CDN content server serving a vantage point, which comprises retrieving an IP address, corresponding to a CDN content server used to serve the vantage point DNS server, from a DNS query to a vantage point DNS server. As an example, when a DNS query is issued to a DNS server that is also an authoritative name server for a CDN, the authoritative name server can return an IP address of the CDN's content server that serves the queried vantage point. In this way, in this example, a CDN's content servers can be identified.

In one embodiment 500 of a method for identifying a CDN content server that serves a vantage point, at 310 in FIG. 5, a canonical name (CNAME) that resolves to a desired number of CDN servers in a desired geographic region can be identified. As an example, in one embodiment, identifying a CNAME may comprise performing a DNS query on web hostnames from a set of hostnames. In this example, a set of web hostnames may be obtained, as described above, by performing web crawling using a search engine. Further, in this example, it can be determined whether the DNS query on a web hostname resolves to a CNAME, and whether the resulting CNAME resolves to the CDN (e.g., using a hostname of the CDN).

In the example embodiment 500, at 504, a DNS query for resolving the identified CNAME can be sent to the vantage point DNS server. As described above, sending a query for resolving a CNAME to an authoritative name server can yield an IP address for the content server serving that authoritative name server. At 506, the IP address that corresponds to a CDN content server that serves the vantage point DNS server can be retrieved. In this way, for example, respective content servers for the CDN can be identified by their IP addresses.

Turning back to FIG. 3, at 312, the exemplary method 300 comprises determining a delay between the CDN content server and the vantage point DNS server. As an example, vantage points for testing are identified that correspond to the CDN's responsive authoritative name servers, and corresponding content servers are identified that serve the respective vantage points. In this way, in this example, a network delay between the vantage point and the content server can be measured. In one embodiment, a CDN wishing to determine potential locations for new data centers can utilize measurements between vantage points and existing content servers to identify those locations yielding desired delay performance results.

Having determined a delay between the CDN content server and the vantage point DNS server, the exemplary method 300 ends at 314.

In one aspect, comprehensive charting of the DNS can involve a large number of DNS queries (e.g., querying respective CDN CNAMEs from all responsive authoritative name servers, as described above). As an example, if a CDN comprises a few thousand CNAMEs, choosing even a small fraction of vantage points (e.g., ten percent) can result in over one hundred million DNS queries. In order to increase a speed of the charting process, reduce a load on any one query server, and to mitigate potential problems resulting from alleged DNS attacks, a distributed execution platform can be utilized for the charting process.

In one embodiment, identifying a set of vantage point DNS servers can comprise dividing the identifying task into more than one smaller tasks. As an example, a list of DNS queries can be compiled and split into several smaller lists. In this embodiment, the smaller tasks can be distributed to more than one computing node to respectively execute the smaller tasks. For example, a series of computers located in geographically disparate locations (e.g., PlanetLab nodes) may be respectively assigned a small tasks (e.g., a portion of the entire list of DNS queries for charting the DNS), which they can execute individually to complete the entire task. In this way, in this example, the large list of DNS queries can be completed in less time than if it was performed by one computer node.

In another aspect, a delay between a content server and a vantage point DNS server can be measured, for example, in order to determine an improved configuration of an edge computing network for a content distribution network. A typical CDN has two major delay components: DNS resolution delay, which is a time for the CDN's internal DNS to supply a client an address of an appropriate CDN content server; and a content-server delay, which is a round-trip time (RTT) between the client and the selected content server. DNS-based delay measurement can be performed using a well known King approach (Gummadi, King: Estimating Latency between Arbitrary Internet End Hosts, ACM IMW, November 2002), which is often used to measure a delay between an arbitrary open recursive DNS server (e.g., one that responds to a DNS query) and another arbitrary DNS server.

In one embodiment, a measurement client can send a DNS query to an open recursive DNS server (e.g., an identified responsive authoritative name server) to resolve a mock name claimed under an authority of a target DNS server (e.g., a DNS server co-located with the target CDN content server). Because the mock name may not be recognized by the target DNS server, the open recursive DNS server should receive a negative response to the query. Once received, a RTT between the open recursive DNS server and the target DNS server can be calculated, for example, by subtracting a RTT from the measurement client to the open recursive DNS server from the total RTT (e.g., the RTT from the measurement client to the target DNS server). In this embodiment, it is possible that the open recursive DNS server may not forward the query to the target DNS server, for example, instead forwarding it to another server that has authority for the same domain. This can become a problem in accurate measurement if the other server is located in a different geographic area.

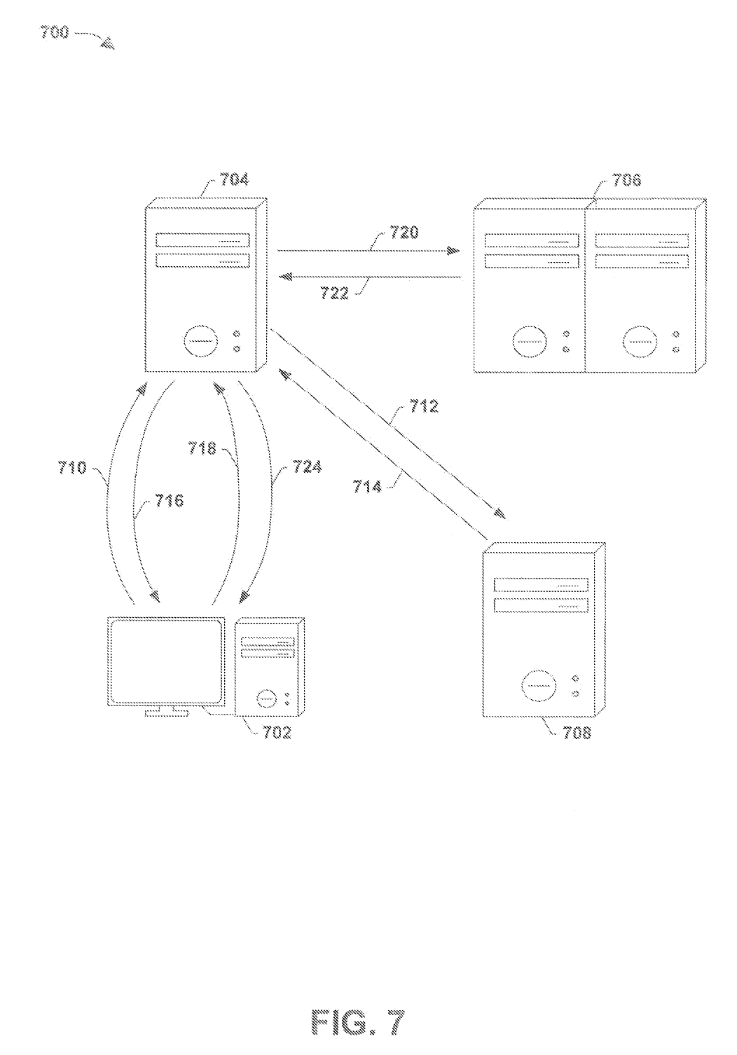

In another embodiment, in order to improve target server accuracy, for example, a measurement domain can be used. In this embodiment a measurement domain can be registered, and a DNS server can be operated for responding to queries for the measurement domain. FIG. 7 is an illustration of an exemplary embodiment of a measurement process 700, comprising a measurement client 702, an open recursive DNS server 704 (e.g., a vantage point DNS server; an identified responsive authoritative name server for a CDN), a target DNS server 706 (e.g., the CDN content server), and a measurement domain server 708. In this exemplary embodiment 700, in order to perform a delay measurement, for example, the measurement client 702 can send a mock DNS query 710 to the open recursive DNS server 704 that asks the target DNS server to resolve a domain name comprising the target server address under the measurement domain (e.g., where T is the target server address and md.net is the measurement domain, the mock query may be T.md.net).

In this example, the mock query 710 causes the open recursive DNS server 704 to query 712 the measurement domain server 708, as it is in charge of the measurement domain (e.g., md.net). The measurement domain server 708 responds 714 with a referral, for example, claiming that a sub-domain comprising the mock query (e.g., T.md.net) is delegated to a mock name server (e.g., mockns.T.md.net), and the address of the mock name server is that of the target DNS server 706. In this example, the open recursive DNS server 704 will forward the response 716 to the measurement client, which can complete a caching the response to the mock query in the open recursive DNS server 704. In this way, in this embodiment, the open recursive DNS server 704 has stored that an authoritative name server for the sub-domain (e.g., T.md.net) is the mock name server having the address of the target DNS server 706 (e.g., the authoritative name server for sub-domain T.md.net is mockns.T.md.net having the target servers address).

In this exemplary embodiment 700, the measurement client 702 can send a second query 718 to resolve a mock hostname in the sub-domain (e.g., mockhn.T.md.net) to the open recursive DNS server 704. In this embodiment, because the authoritative name server for this sub-domain has been cached, the open recursive DNS server 704 forwards the second query 720 to the target DNS server 706. The target DNS server 706 responds with an error message 722, as the query comprise mock information, for example. The error message, in this example, can be forwarded 724 back to the measurement client 702. In this exemplary embodiment, the second query returned back to the measurement client can comprise a RTT between the open recursive DNS server 704 and the target DNS server 706, thereby enabling a delay measurement between these servers.

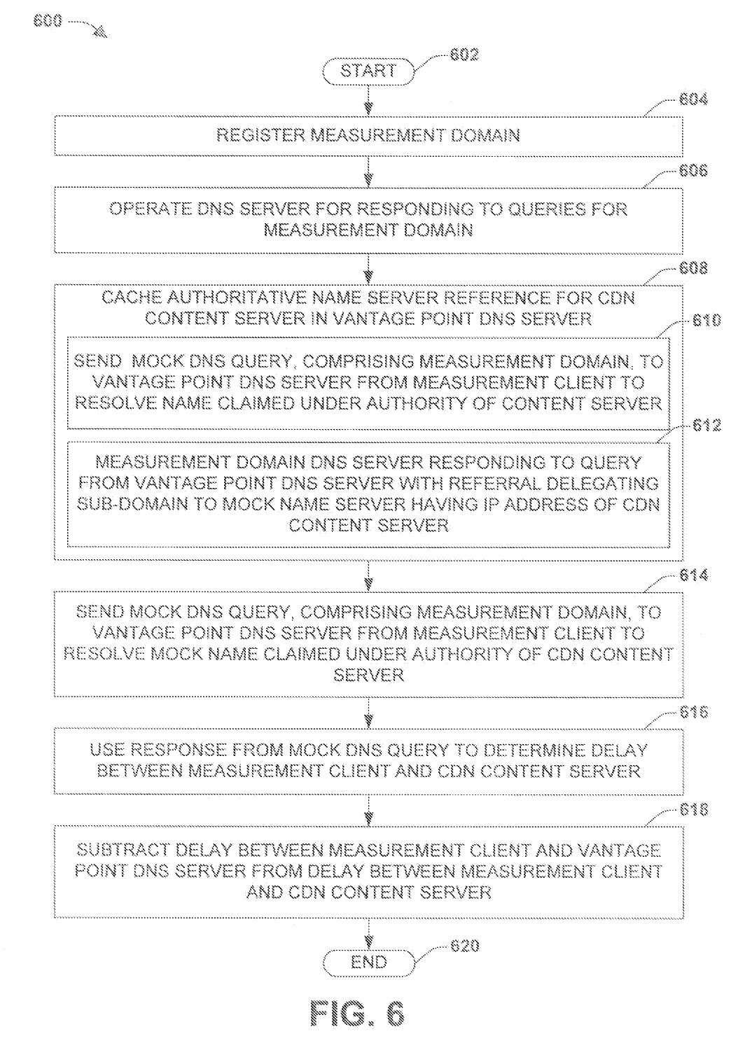

FIG. 6 is a flow chart diagram illustrating another exemplary embodiment of a method 600 for determining delay between a CDN content server and a vantage point domain name system (DNS) server, comprising a portion of a method for determining delay performance of an Internet content provider using network latency between a content server in a content delivery network (CDN) and domain name system (DNS) server (e.g., as in 312 of FIG. 3). The exemplary embodiment of the method 600 begins at 602 and involves registering a measurement domain, at 604. At 606, a DNS server can be operated for responding to queries for the measurement domain.

At 608, an authoritative name server reference for a target CDN content server can be cached in a vantage point server. In one embodiment, caching the authoritative name server reference can comprise, at 610, a measurement client sending a mock DNS query, comprising the measurement domain, to the vantage point DNS server to resolve a name claimed under an authority of the target content server. Further, in this embodiment, at 612, caching the authoritative name server reference can comprise the measurement domain responding to a query from the vantage point DNS server, with a referral that delegates a sub-domain to a mock name server having an IP address of the target CDN content server. In this way, as an example, the vantage point DNS server has stored that an authoritative name server for the sub-domain is the mock name server having the address of the target CDN content server, as described above.

At 614, in the exemplary embodiment of the method 600, a mock DNS query, comprising the measurement domain, is sent to the vantage point DNS server from the measurement client to resolve a mock name claimed under the authority of the CDN content server. At 616, a response from the mock DNS query is used to determine a delay between the measurement client and the CDN content server. At 618, the delay between the vantage point DNS server and the CDN content server can be determined, for example, by subtracting the delay between the measurement client and the vantage point DNS server from the total delay (e.g., delay between the measurement client and the CDN content server).

In another aspect, certain open recursive DNS servers (e.g., authoritative name servers that respond to queries) may not be desirable for use in measuring delay performance of a CDN, for example, to determine a CDN's delay performance improvements. As an example, a significant portion of open recursive DNS servers may be behind forwarders, which can forward queries to resolver servers at another location, possibly in a different geographical area. In this example, the servers that are behind forwarders may not be desirable for vantage point measurements, as results may not be accurate. Additionally, some open recursive DNS servers may attempt to contact the measurement domain server multiple times during a retrial, after receiving an error message from the target CDN content server (e.g., as described in the exemplary method above). Such retrials may happen at differing intervals, or even using a different protocol, which could result in inaccurate delay measurements. Therefore, in this aspect, it may be desirable to filter out open recursive DNS servers that are behind forwarders, and those that are retrial servers.

In one embodiment, undesirable vantage point DNS servers can be filtered out, for example, and not used for determining a CDN delay performance. In this embodiment, a measurement domain server can check to see if a source address in a query matches to a vantage point DNS server. For example, during a delay measurement, when the vantage point DNS queries the measurement domain server, the measurement domain server can check the source address from the query to see if it came from the vantage point DNS server, or from another server (e.g., behind a forwarder). In this embodiment, if no match is found, the measurement domain can respond to the query with a referral to a mock name server used as an identifier that no match was found. When the response is forwarded to the measurement client, for example, the measurement client can detect that no match was found by the mock name used, and filter out the particular DNS server from the vantage points.

In another embodiment, for example, the measurement domain server can detect retrial attempts from a retrial server. In this example, detected retrial servers can then be removed from a set of vantage point DNS servers used for measuring delays in the CDN. Additionally, in this example, delay measurement logs can be checked for the measurement server to determine whether any retrial servers were utilized in the delay measurement. These retrial servers can be removed from potential delay performance measurements, for example.

In another aspect, there may be situations where accuracy of delay measurement can be improved by grouping CDN content servers into clusters. As an example, if a vantage point DNS server has been identified and a CDN content server has been identified, using the techniques described herein, one can determine a delay between these two servers. In this example, If one wished to determine a delay between a second content server in a same cluster as a first content server, from the vantage point DNS, measuring the delay between the first content server and the vantage point DNS server may be appropriate, as long as the first and second content server have been clustered appropriately.

In one embodiment, CDN content servers can be grouped into cluster based on a desired network delay between respective content servers. As an example, one may set a network delay threshold between content servers in order to group them into a cluster. In this embodiment, a delay between a last hop router and respective IP addresses of the content servers can be used for comparison against a set threshold value. Therefore, for example, if the delay from the last hop router and the IP address of a second content server meets the threshold from a first content server, the two servers may be grouped in a same cluster. In this way, for example, measuring the delay between the first content server and the vantage point DNS server may be used for the second content server.

In another aspect, one may wish to deploy a new CDN, which may involve determining one or more locations for data centers (e.g., edge computing centers) to serve the CDN, or add one or more new data centers to an already existing content delivery system, for example, in order to improve performance (e.g., content delivery speed). In this aspect, in one embodiment, a CDN that wishes to determine a location for one or more data centers can evaluate one or more delay performances for one or more sets of potential data center locations.

As an example, one wishing to deploy a new CDN can use locations of an existing CDNs collocated DNS servers (e.g., collocated to content delivery servers for the existing CDN) as potential locations for new data centers. In this way, in this example, utilizing the techniques described above one can determine delay performances for respective arrangements of the existing CDNs collocated DNS servers with desired identified vantage points (e.g., comprising open recursive authoritative name servers). Further, in this example, desired vantage points can be weighted based on a potential client distribution for the new CDN deployment (e.g., geographic locations of the vantage points selected based on expected content delivery volume for geographic areas) so that a vantage points corresponding to more clients receive a heavy weight. Based on the delay performance for respective arrangements of the existing CDNs collocated DNS servers to the desired vantage points, for example, one can select an arrangement for new data center deployment based that supplies a desired weighted performance (e.g., one that can deliver content at a speed to meets client needs) where the weight of the vantage point is considered.

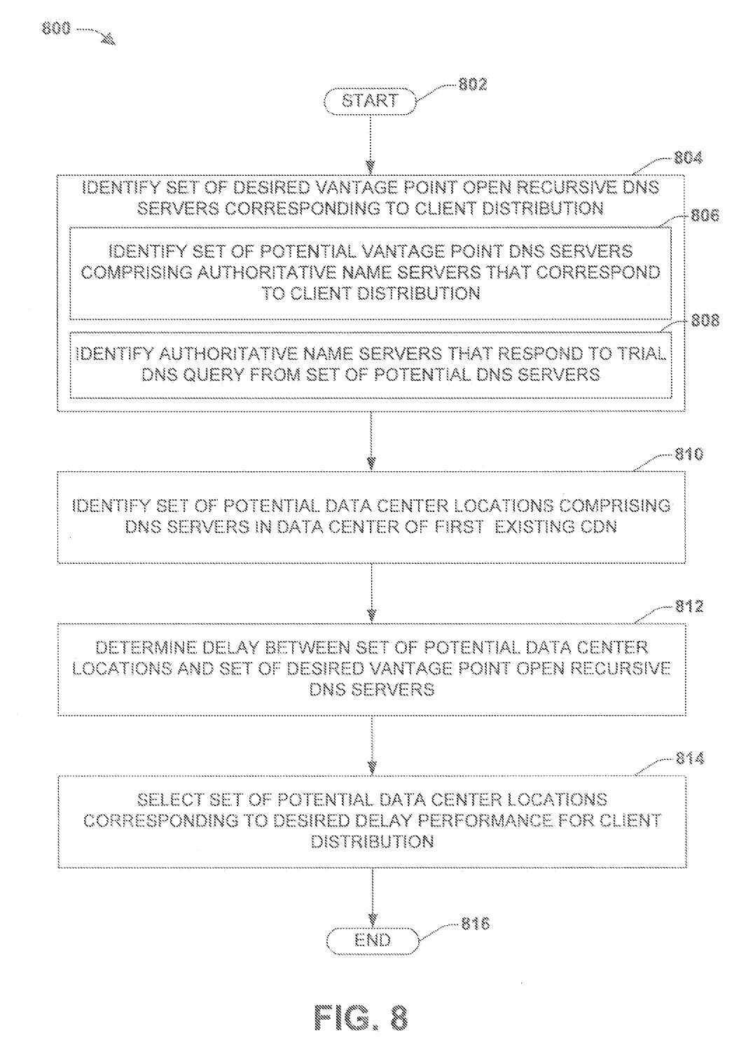

FIG. 8 is a flow chart diagram illustrating an exemplary method 800 for determining a desired location of one or more data centers for a CDN based on a delay performance. The exemplary method 800 begins at 802 and involves identifying a set of desired vantage point open recursive DNS servers that correspond to client distribution, at 804. As an example, a CDN that wishes to deploy new data centers can evaluate an expected volume of content distribution for their network by geographic area. In this example, the CDN will can choose a location and amount of vantage points based on expected volume in particular geographic areas.

In the exemplary method 800, at 806, identifying a set of desired vantage points can comprise identifying a set of potential vantage point DNS servers that are authoritative name servers corresponding to client distribution. Further, at 808, one can identify those authoritative name servers, from the set of potential DNS servers, which respond to a trial DNS query. For example, one can query a set of DNS servers that are the identified authoritative name servers to determine which ones respond. In this example, those authoritative name servers that respond are considered to be open recursive DNS servers, and can be utilized for delay performance determination for potential new data center deployment locations.

At 810, in the exemplary method 800, one can identify a set of potential data center locations, which are DNS servers collocated with CDN content server serving a vantage point. In this embodiment, the identifying comprise retrieving an IP address from a DNS query to a vantage point DNS server, where the IP address corresponds to a collocated DNS server used to serve the vantage point DNS server. As an example, when a DNS query is issued to a DNS server that is an authoritative name server collocated with a content server for a CDN, the authoritative name server can return an IP address of the CDN's content server that serves the queried vantage point. In this way, in this example, a CDN's content servers location can be identified, and used as a potential new data center location.

At 812, a delay is determined between the set of potential data center locations and a set of desired vantage point open recursive DNS servers. In one embodiment, a delay performance for respective arrangements of the potential data centers can be determined for respective vantage points in the set of desired vantage points (e.g., selected based on expected content distribution). In this way, respective arrangements of potential data centers can produce a variety of delay performance results (e.g., that can be utilized for a variety of potential client content distribution arrangements), for example. As an example, if ten potential data center locations were identified (e.g., utilizing another existing CDN's server deployment), one may determine a delay performance for each combination of a potential data centers to determine.

At 814, one can select a set of potential data center locations (e.g., a combination of locations) that correspond to a desired delay performance for client distribution. For example, based on an expected content distribution for a CDN, one may select a combination of potential data centers that can meet delay performance requirements for the expected client base. In this example, the selected data center locations may be less than all of the potential data centers identified by the method.

In another embodiment, in this aspect, one may wish to use vantage points to determine potential delay improvements by adding a particular data center location to their existing network (e.g., using a location from another existing CDN). As an example, the CDN could measure delay performance between a vantage point and their existing data centers, and between the vantage points and another CDN's data centers to choose desired locations for new data centers (e.g., based on the other CDN's locations).

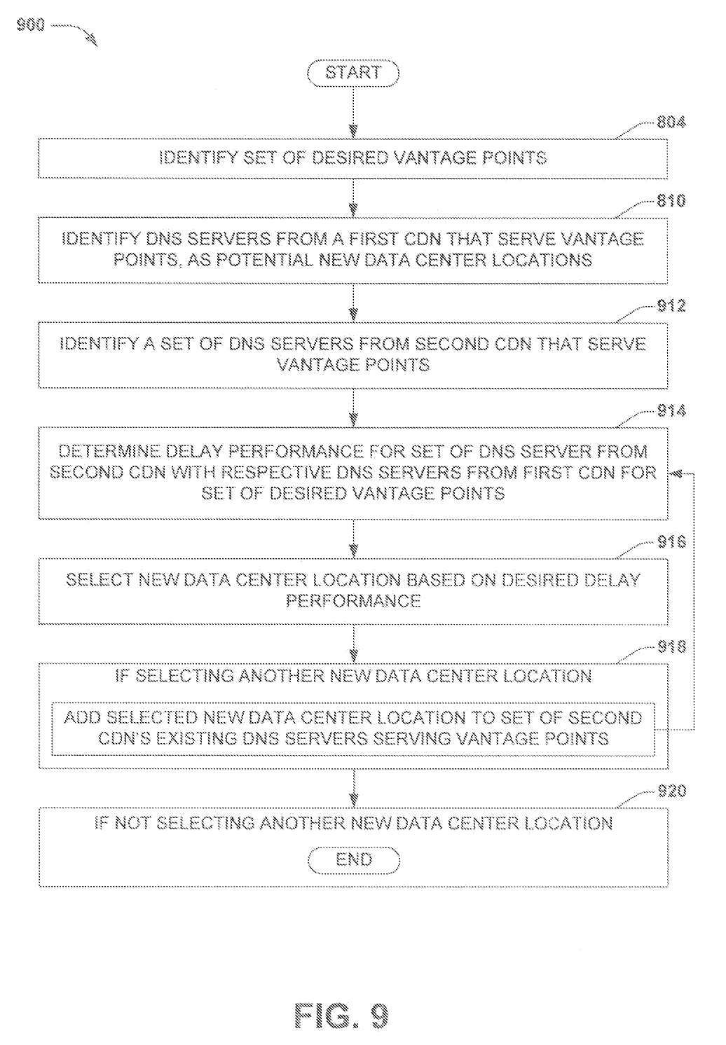

FIG. 9 is a flow chart diagram illustrating an exemplary embodiment 900 of the method 800, for determining one or more locations to deploy a new data center in an existing first CDN, in association with determining delay performance of an existing second CDN. At 804 of the exemplary embodiment 900, a set of desired vantage points can be identified, as described above in FIG. 8, 800. At 810, a set of DNS servers from a first existing CDN that serve the vantage points, are identified for use as potential data center locations, as described above in FIG. 8, 800. As an example, a first existing CDN may be a CDN that is already has data centers deployed in locations that a second CDN wishes to evaluate for potential data center deployment.

At 912, in the exemplary embodiment 900, a set of a second CDN's existing DNS servers collocated with the second CDN's content servers serving a vantage point are identified, for example, for comparison with the DNS servers from the first CDN. As an example, a second CDN may be an existing CDN that wishes to add one or more data centers, and is evaluating locations for deployment. In this example, the second CDN's content servers also serve the vantage points that the first CDN's content servers serve.

At 914, a delay performance is determined for a set of the second CDN's existing DNS servers with respective first CDN's existing DNS servers, from the set of a first CDN's existing DNS servers collocated with the first CDN's content servers serving a vantage point, for the set of desired vantage point open recursive DNS servers. As an example, one can determine a delay performance for the set of the second CDN's servers with an addition of one of the first CDN's servers from the set of identified DNS servers from the first CDN. Further, in this example, delay performances can be determined for the set of the second CDN's servers with an addition of one of each of the first CDN's servers from the set of identified DNS servers from the first CDN, thereby yielding a series of delay performances corresponding to an addition of a data center at respective locations of the second CDN servers.

At 916, a new data center for a second CDN can be selected based on a desired performance delay. For example, the performance delays determined in 914 can be ranked according to a level of delay performance (e.g., a delay performance that meets content delivery needs of the second CDN's client distribution). In this example, a potential data center location (e.g., corresponding to a first CDN's server location) can be selected based on it delay performance rank (e.g., first on the list). In one embodiment, if the second CDN has a DNS server at a same location as the potential data center location having the desired rank in the list, and the delay performance for the second CDN's server is better than that of the selected data center location (e.g., from the first CDN), then one can choose to use the data center from the second CDN (e.g., use the location of the already existing center for the CDN instead of one from another CDN).

At 918, in the exemplary embodiment 900, if a second new data center location is to be selected, the new data center location that was previously selected (as in 916 above) can be added to the set of existing DNS servers serving the vantage points for the second CDN. As an example, if after selecting a first new data center location the second CDN wishes to identify a second new data center location, the first new data center location can be added to the second CDNs current data centers. In this way, in this example, a desired delay performance can be determined for the second new data center location with the first new data center already in place in the second CDN.

Further, after adding the first new data center to the set of a second CDN's DNS servers, one can go back to 914 to determine a delay performance for the CDNs, as described above. Additionally, these steps can be repeated (e.g., 916→918→914 . . . ) to add a desired number of new data center locations. On the other hand, at 920, of not selecting another new data center location, the exemplary method 900 ends.

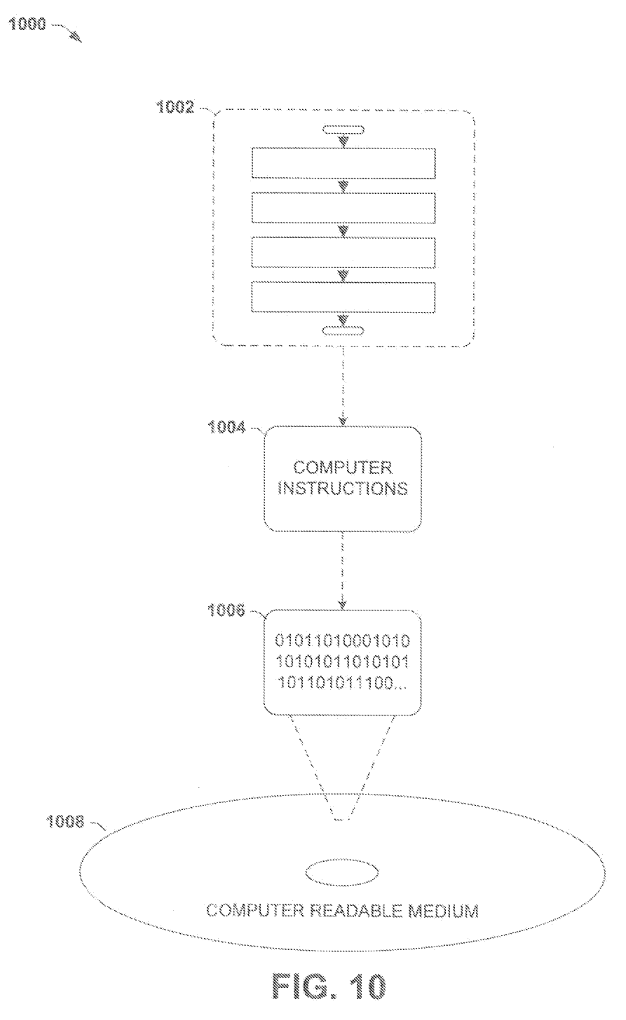

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1008 (e.g., a CD-R, DVD-R, or a platter of a hard disk drive), on which is encoded computer-readable data 1006. This computer-readable data 1006 in turn comprises a set of computer instructions 1004 configured to operate according to one or more of the principles set forth herein. In one such embodiment 1000, the processor-executable instructions 1004 may be configured to perform a method 1002, such as the exemplary method 300 of FIG. 3, for example. In another such embodiment, the processor-executable instructions 1004 may be configured to perform another method 1002, such as the exemplary method 800 of FIG. 8, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

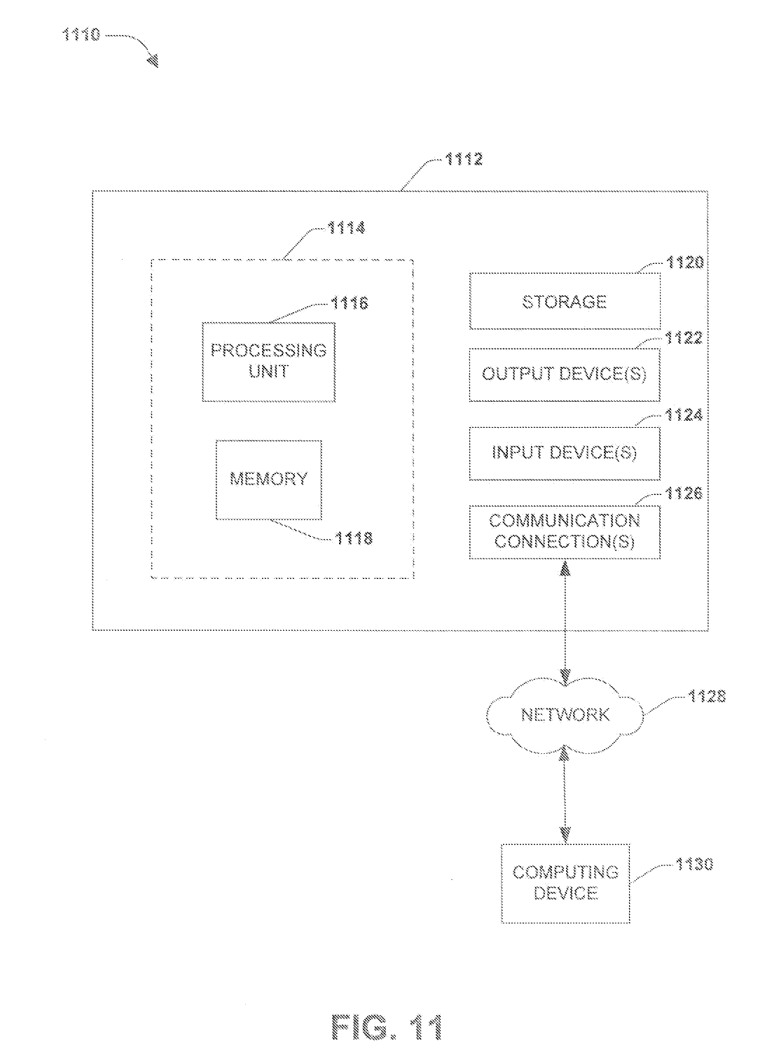

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method for determining delay performance of an Internet content provider using network latency between a target server and one or more vantage point domain name system (DNS) servers, comprising:
identifying a set of vantage point DNS servers, comprising:
identifying a set of potential vantage point DNS servers comprising authoritative name servers; and
identifying responsive authoritative name servers as open recursive DNS servers comprising identifying authoritative name servers that respond to a trial DNS query from a remote client;
identifying a local DNS (LDNS) server co-located with the target server serving a vantage point comprising retrieving an IP address from a DNS query to a vantage point DNS server, the IP address corresponding to the target server used to serve the vantage point DNS server; and
determining a delay between the LDNS server and the vantage point DNS servers.

2. The method of claim 1, identifying a set of authoritative name servers to use as potential vantage points comprising at least one of:
using a reverse DNS lookup to identify authoritative name servers corresponding to IP addresses from a set of IP addresses; and
using a reverse DNS lookup to identify authoritative name servers corresponding to web hostnames from a set of web hostnames.

3. The method of claim 1, the target server comprises a DNS server in a content delivery network (CDN), and the LDNS server merely comprises the DNS server.

4. The method of claim 3, identifying the LDNS server co-located with the content server comprising:
identifying a canonical name (CNAME) that resolves to a desired number of CDN servers in a desired geographic region;
sending a query to one of the vantage point DNS servers, the query comprising a DNS query for resolving the identified CNAME; and
retrieving an IP address from the DNS query, the IP address corresponding to a CDN content server used to serve the vantage point DNS server.

5. The method of claim 3, identifying a CNAME comprising:
performing a DNS query on web hostnames from a set of hostnames;
determining if the DNS query of a web hostname resolves to a canonical name (CNAME); and
determining if a CNAME query resolves to a hostname of the CDN;

6. The method of claim 1, identifying a set of vantage point DNS servers using a distributed execution platform comprising:
dividing the identifying task into more than one smaller tasks; and
distributing the smaller tasks to more than one separate computing node to perform an assigned task.

7. The method of claim 1, comprising grouping target servers into clusters based on a desired network delay between the target servers in the cluster and the vantage point DNS servers.

8. The method of claim 1, determining a delay between the target server and the vantage point DNS server comprising:
sending a mock DNS query to the vantage point DNS server from a measurement client to resolve a mock name claimed under an authority of the LDNS server;
using a response from the mock DNS query to determine a delay between the measurement client and the LDNS server; and
subtracting a delay between the measurement client and the vantage point DNS server from the delay between the measurement client and the LDNS server.

9. The method of claim 8, determining a delay between the LDNS server and the vantage point DNS server comprising:
registering a measurement domain;
operating a DNS server for responding to queries for the measurement domain; and
caching an authoritative name server reference for the LDNS server for the vantage point DNS server, the authoritative name server reference for the LDNS server comprising the measurement domain.

10. The method of claim 9, caching comprising:
sending a DNS query to the vantage point DNS server from the measurement client to resolve a name, comprising the measurement domain, claimed under an authority of the LDNS server; and
the measurement domain DNS server responding to the query from the vantage point DNS server with a referral delegating a sub-domain to a mock name server having an IP address of LDNS server.

11. The method of claim 8, determining a delay between LDNS server and the vantage point DNS server comprising filtering out undesirable vantage point DNS servers

12. The method of claim 11, filtering out vantage point DNS servers that are behind forwarders comprising:
the measurement domain server checking if a source address in a query matches to the DNS server;
if no match is found the measurement domain server responding with a referral that comprises a name server identifying that no match was found; and
the measurement client, detecting that no match was found, filtering out the DNS server.

13. The method of claim 11, comprising filtering out retrial DNS servers comprising DNS servers that attempt to contact a measurement domain DNS server after an error message is received.

14. The method of claim 7, grouping target servers into clusters comprising:
identifying a common last hop router for the target servers;
measuring a network delay between the last hop router and a desired number of target servers behind the last hop router; and
clustering target servers based on a network delay threshold value.

15. A method for determining a desired location of one or more data centers based on a delay performance, comprising:
identifying a set of desired vantage point open recursive domain name system (DNS) servers corresponding to a client distribution, comprising:
identifying a set of potential vantage point DNS servers comprising authoritative name servers that correspond to client distribution; and
identifying responsive authoritative name servers from the set of potential vantage point DNS servers comprising identifying authoritative name servers that respond to a trial DNS query;
identifying a set of potential data center locations comprising DNS servers in a data center of a first existing content delivery network (CDN);
determining a delay between the set of potential data center locations and the set of desired vantage point open recursive DNS servers; and
selecting a set of potential data center locations corresponding to a desired delay performance for the client distribution.

16. The method of claim 15, comprising:
identifying a set of a second CDN's existing DNS servers collocated with the second CDN's content servers serving a vantage point;
determining a delay performance for a set of the second CDN's existing DNS servers with respective first CDN's existing DNS servers, from the set of a first CDN's existing DNS servers collocated with the first CDN's content servers serving a vantage point, for the set of desired vantage point open recursive DNS servers;

17. The method of claim 16, selecting a set of potential data center locations comprising:
selecting a new data center location to add to the second existing CDN from a set of potential data center locations based on a desired delay performance determined for the set of the second CDN's existing DNS servers with the respective first CDN's existing DNS servers, from the set of a first CDN's existing DNS servers collocated with the first CDN's content servers serving a vantage point; and
if selecting a location for another new data center to add to the second CDN:
adding the selected new data center to the set of the second CDN's existing DNS servers collocated with the CDN's content servers serving a vantage point; and
determining a delay between the identified set of the first CDN's existing DNS servers and the set of desired vantage point open recursive DNS servers.

18. The method of claim 17, if a first CDN comprises an existing DNS server in a same location as a second CDN's existing DNS servers collocated with the second CDN's content servers, select the existing DNS server from the CDN having a desired delay performance.

19. The method of claim 15, the client distribution comprising a weighted geographic distribution based on an amount of content distribution from a CDN.

20. A method for determining delay performance of an Internet content provider using network latency between a content server in a content delivery network (CDN) and vantage point domain name system (DNS) servers, comprising:
identifying a set of DNS servers for use as vantage points, comprising:
locating DNS servers to use as potential vantage points
identifying responsive authoritative name servers comprising identifying the located DNS servers that respond to a trial DNS query;
identifying a CDN content server serving a vantage point comprising:
identifying a canonical name (CNAME) that resolves to a desired number of CDN servers in a desired geographic region;
sending a query to the DNS server corresponding to a vantage point, the query comprising a DNS query for resolving the identified CNAME; and
retrieving an IP address from the DNS query, the IP address corresponding to a CDN content server used to serve the vantage point DNS server; and
determining a delay between the CDN content server and the vantage point DNS server comprising:
sending a mock DNS query to the vantage point DNS server from a measurement client to resolve a mock name claimed under an authority of the CDN content server;
using a response from the mock DNS query to determine a delay between the measurement client and the CDN content server; and
subtracting a delay between the measurement client and the vantage point DNS server from the delay between the measurement client and the CDN content server.
